(19) United States
(12) Patent Application Publication
(10) Pub. No.: US 2026/0059280 A1
(43) Pub. Date: Feb. 26, 2026

(54) RAN INTELLIGENT CONTROLLER (RIC) CONFLICT MANAGEMENT AND MITIGATION FRAMEWORK

(71) Applicant: Juniper Networks, Inc., Sunnyvale, CA (US)

(72) Inventors: Arda Akman, San Ramon, CA (US); Burcu Sahin, San Jose, CA (US); Oguz Oktay, Sunnyvale, CA (US); Constantine Dimitrios Polychronopoulos, Saratoga, CA (US); Bengi Mizrahi, Istanbul (TR); Georgios Oikonomou, Patra (GR)

(21) Appl. No.: 19/307,594

(22) Filed: Aug. 22, 2025

(30) Foreign Application Priority Data
Aug. 22, 2024 (GR) 20240100589

(51) Int. Cl. H04W 4/50

(52) U.S. Cl. CPC H04W 4/50

(57) ABSTRACT

In general, the disclosure describes techniques for an extensible conflict management and mitigation framework for a RAN Intelligent Controller (RIC) for a RAN of a mobile network. In an example, a method includes storing, by a computing system to a signals database, signals, each of the signals comprising one or more of: a message communicated via an interface, an event reported via the interface, or an action directed via the interface, wherein the interface comprises an A1 interface, an O1 interface, an O2 interface, or an E2 interface for a Radio Access Network (RAN); managing, by the computing system, the RAN via the interface; subscribing, by a conflict manager of the computing system, to obtain signals associated with the interface and stored to the signals database; and based on the obtained signals, by the conflict manager, mitigating or managing a conflict among services implemented in the RAN.

This application claims the benefit of Greece Patent Application No. 20240100589, filed 22 Aug. 2024, which is incorporated by reference herein in its entirety.

### TECHNICAL FIELD

The disclosure relates to computer networking, and to conflict management and mitigation in a mobile network.

### BACKGROUND

Computer networks have become ubiquitous, and the number of network applications, network-connected devices, and types of network-connected devices are rapidly expanding. Such devices now include computers, smartphones, Internet-of-Things (IoT) devices, vehicles, medical devices factory equipment, etc. 5G mobile network architectures enhanced the ability to provide communication services using cloud-based network function virtualization (NFV). Specialized networks can be created using the Radio Access Network (RAN) of a mobile network operator combined with functions of a 5G core. For example, networks can be created for a specific service level agreement (SLA), special use cases, or other specific requirements. Examples of such networks include private mobile networks, industrial networks, a dedicated network for connected vehicles, etc.

### SUMMARY

In general, the disclosure describes techniques for an extensible conflict management and mitigation framework for a RAN Intelligent Controller (RIC) for a RAN of a mobile network. For example, a network system may include a Service Management and Orchestration (SMO) framework for a mobile network, the SMO offering various framework functions along with a non-real-time (non-RT) RIC, configured in accordance with Open Radio Access Network (O-RAN) standards (“O-RAN architecture”), to manage and/or monitor aspects of a RAN and/or 5G core. The O-RAN architecture may include a non-RT RIC and a near-real-time RIC (near-RT RIC) that each executes different functions and services for RAN functions. For example, the non-RT RIC is an orchestration and automation function configured to provide radio resource management, higher layer procedure optimization, policy optimization, and provide guidance, parameters, policies and AI/ML models to support the operation of near-RT RIC functions in the RAN. The non-RT RIC may onboard one or more applications (e.g., rApps) that provide non-real time (e.g., greater than one second) control of RAN elements and their resources, and the near-RT RIC may onboard one or more applications (e.g., xApps) that provide near-real time control of RAN elements and their resources. The O-RAN architecture includes several interfaces, such as A1, O1, and O2 interfaces, that are each used to provide the functions and services by which the SMO and RIC can configure or direct other components of the RAN. For example, the functions and services of a non-RT RIC may include policy management services and/or enrichment information services for a near-RT RIC that are provided over an A1 interface (collectively referred to herein as “A1 services” because they provided over the A1 interface); Operations, Administration, and Management (OAM) services, such as performance management services and configuration management services, for O-RAN management elements that are provided over an O1 interface (referred to herein as “O1 services” because they are provided over the O1 interface); infrastructure management services and deployment management services for resources of an O-RAN cloud that are provided over an O2 interface (referred to herein as “O2 services” because they are provided over the O2 interface), and/or other services, such as service management and exposure (SME) services (e.g., registration of a service, update of a service registration), data management and exposure (DME) services, and/or AI/ML services.

RIC conflict management and mitigation is a challenging problem, and there are no easy/apparent and/or standards-defined solutions. RIC conflict management and mitigation is also a common problem, particularly since the introduction of different optimization algorithms (such as Self-Organizing Network (SON) algorithms) by which different applications implementing SON functionality can modify the configuration of the network. The issue is getting ever more complex with the O-RAN RIC architecture and the simultaneous existence and execution of multiple vendor applications (e.g., r/xApps).

The extensible conflict management and mitigation framework described herein allows a conflict manager to subscribe to signals stored by the RIC. The conflict manager may be a component of SMOs for various enterprises, mobile network operators, or providers associated with the RAN managed by the RIC; the conflict manager may also or alternatively be a separate application associated with various third parties, which may also be enterprises, mobile network operators, or providers. The conflict manager may also or alternatively be an application of the RIC platform. The conflict manager may be pluggable within an extensible platform. The conflict manager may implement an artificial intelligence (AI)/machine learning (ML)-based approach to conflict management and mitigation. The signals stored by the RIC can include messages communicated via interfaces; events reported via interfaces; and/or actions directed and optionally reported via the interfaces, where the interfaces may include, for examples, the O1, A1, O2, and E2 interfaces. The RIC may store such signals in association with network data representative of the state of the mobile network at the time of a signal.

The conflict manager subscribes to the RIC to obtain signals (and optionally associated network data) determined as useful for conflict management and mitigation. Based on the obtained signals, the conflict manager may identify conflicts. The conflict manager may then provide feedback and direct or otherwise communicate with the RIC to mitigate and/or manage the identified conflicts.

The techniques provide one or more technical advantages that realize improvements to the computer-related field of conflict management and mitigation within mobile networks that are integrated within one or more practical applications. For example, the techniques may enable a dynamic and flexible approach to conflict mitigation and management. Rather than conflict management and mitigation strategies being statically programmed into the RIC, or necessarily defined in the RIC, as may be done conventionally, a separate or pluggable conflict manager—as described herein—may be used by the mobile network operator (or other party) to identify and mitigate and/or manage conflicts. As another example, the extensible framework allows for future improvements as well as introduction of additional conflict management and mitigation applications by third parties. As another example, the conflict manager can leverage the signals stored by the RIC to identify, optionally using AI/ML, correlations in the network state that relate to conflicts and develop additional mitigation and/or management strategies to address the conflicts while balancing user intents and network goals.

In an example, a computing system comprises one or more storage devices; and processing circuitry having access to the one or more storage devices and configured to execute a Radio Access Network (RAN) Intelligent Controller (RIC) comprising: a signals database configured to store signals, each of the signals comprising one or more of: a message communicated via an interface, an event reported via the interface, or an action directed via the interface, wherein the interface comprises an A1 interface, an O1 interface, an O2 interface, or an E2 interface for a RAN; and one or more managers to manage the RAN via the interface; and a conflict manager configured to: subscribe to obtain signals associated with the interface and stored by the signals database; and based on the obtained signals, mitigate or manage a conflict among services implemented in the RAN.

In an example, a method includes storing, by a computing system to a signals database, signals, each of the signals comprising one or more of: a message communicated via an interface, an event reported via the interface, or an action directed via the interface, wherein the interface comprises an A1 interface, an O1 interface, an O2 interface, or an E2 interface for a Radio Access Network (RAN); managing, by the computing system, the RAN via the interface; subscribing, by a conflict manager of the computing system, to obtain signals associated with the interface and stored to the signals database; and based on the obtained signals, by the conflict manager, mitigating or managing a conflict among services implemented in the RAN.

In an example, non-transitory computer-readable media comprises instructions that, when executed, cause processing circuitry of a computing system to store, to a signals database, signals, each of the signals comprising one or more of: a message communicated via an interface, an event reported via the interface, or an action directed via the interface, wherein the interface comprises an A1 interface, an O1 interface, an O2 interface, or an E2 interface for a Radio Access Network (RAN); manage the RAN via the interface; subscribe, by a conflict manager, to obtain signals associated with the interface and stored to the signals database; and based on the obtained signals, by the conflict manager, mitigate or manage a conflict among services implemented in the RAN.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a block diagram illustrating an example network system configured to provide conflict management and mitigation among functions and/or services in a mobile network, in accordance with one or more techniques of the disclosure.

FIG. 1B is a block diagram illustrating further example details of the non-RT RIC of the Service Management and Orchestration system of FIG. 1A.

FIG. 2 is a block diagram illustrating an example computing system in detail, in accordance with the techniques of this disclosure.

FIG. 3 is a conceptual diagram illustrating operations by services of a Service Management and Orchestration system, including a RIC, to avoid or mitigate conflicts that affect resources of a RAN.

FIG. 4 is a flowchart illustrating an example mode of operation, in accordance with one or more aspects of this disclosure.

Like reference characters denote like elements throughout the text and figures.

### DETAILED DESCRIPTION

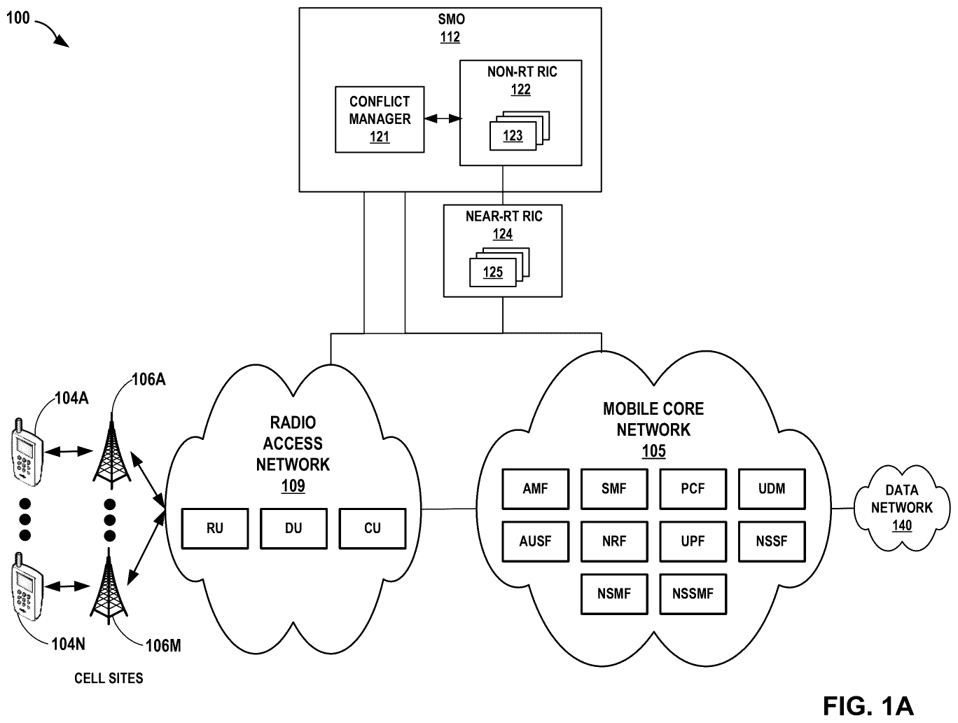

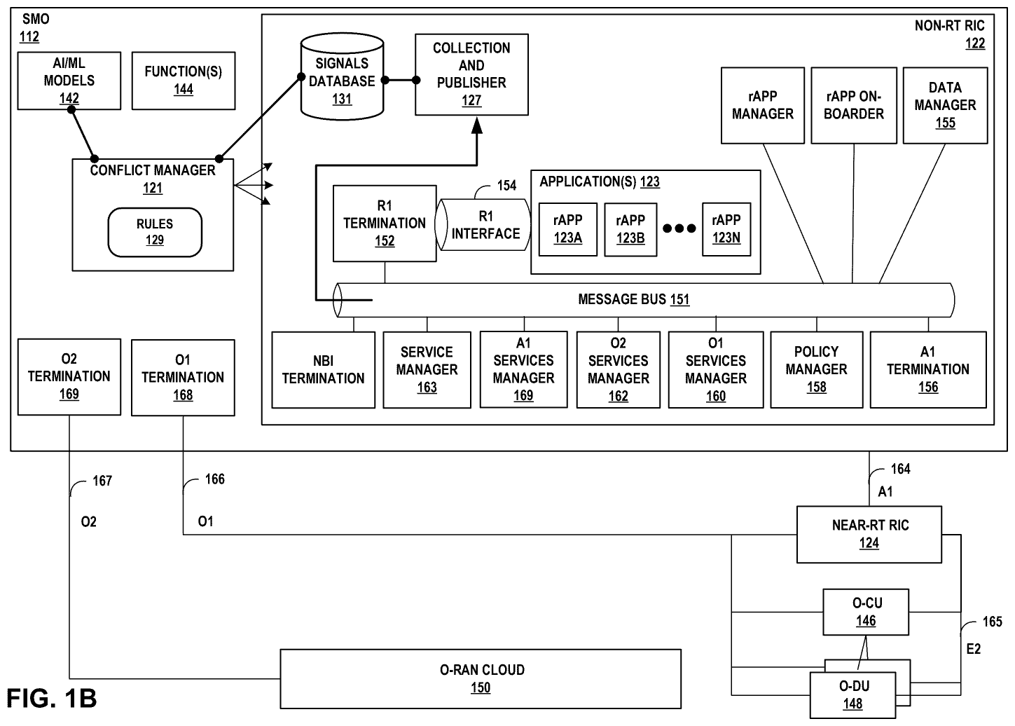

FIG. 1A is a block diagram illustrating example network system 100 configured to provide conflict management and mitigation among functions and/or services in a mobile network, in accordance with one or more techniques of the disclosure. In the example illustrated in FIG. 1A, network system 100 includes Service and Management Orchestrator system 112 (“SMO 112”), non-RT RIC 122, near-RT RIC 124, one or more radio access networks (RANs), e.g., RAN 109, and mobile core network (or simply “core”) 105 that provide user equipment 104A-104N (collectively, “UEs 104”) with access to one or more applications or services provided by data network 140.

UEs 104 may represent smartphones, desktop computers, laptop computers, tablets, smart watches, and/or “Internet-of-Things” (IOT) devices, such as cameras, sensors, televisions, appliances, or the like. As shown in FIG. 1A, network system 100 includes RAN 109 that provides network access, data transport, and other services to UEs 104. In some examples, RAN 109 may be an Open Radio Access Network (O-RAN), a 5G mobile network RAN, a 4G LTE mobile network RAN, another type of RAN, or a combination of the above. For example, in a 5G-radio access network, RAN 109 comprises a plurality of cell sites (or simply “cells”) that each include radio equipment, such as base stations 106A-106M (collectively, “base stations 106”), also known as gNodeBs for 5G mobile networks, to exchange packetized data to ultimately access one or more applications or services provided by data network 140. Each of base stations 106 is divided into three functional components: radio unit (RU), distributed unit (DU), and central unit (CU), which can be deployed in various configurations. RU manages the radio frequency layer and has antenna arrays of various sizes and shapes. DU performs lower layer protocol processing. CU performs the upper layer protocol processing. Depending on operator and service requirements, base stations 106 can be deployed monolithically, e.g., RU, DU, and CU reside within a cell site, or these functionalities can be distributed across cell sites while the CU resides in an edge cloud site controlling a plurality of distributed DUs. O-RAN is, for example, an approach to networking in which disaggregated functions can be used to deploy mobile fronthaul and midhaul networks. The disaggregated functions can be cloud-based functions.

Radio access networks 109 connect to core 105 to exchange packets with data network 140. Core 105 may be a 5G core network, and data network 140 may represent, for example, one or more service provider networks and services, the Internet, third party services, one or more IP-VPNs, an IP-multimedia subsystem, a combination thereof, or other network or combination of networks. In some examples, resources associated with the service provided by a mobile network operator to the tenant may be provided by, or managed by, functions of core 105 and/or components of RAN 109. In some examples, core 105 implements various discrete control plane and user plane functions for network system 100. Examples of 5G control plane functions that may be provided by core 105 include Access Mobility Management Function (AMF) that provides access mobility management services, Session Management Function (SMF) that provides session management services, Policy Control Function (PCF) that provides policy control services, User Data Management (UDM) that provides management of network user data, Network Repository Function (NRF) that provides a repository that can be used to register and discover services in a network operator's network, Authentication Server Function (AUSF) that provides authentication services, Network Slice Selection Function (NSSF), Network Slice Management Function (NSMF) that may be used to select an instance of an available network slice for use by any of UE devices 104, and Network Slice Subnet Management Function (NSSMF) that provides coordination, management, and orchestration of network slice subnet instances (NSSI). Core 105 may also include User Plane Functions (UPF) that provides packet routing, forwarding and other network data processing functions (e.g., Quality of Service, packet inspection, traffic optimization etc.). Further details on services and functions provided by the 5G core, can be found in 3^{rd} Generation Partnership Project 2021, Technical Specification Group Services and System Aspects; System architecture for the 5G System (5GS); Stage 2 (Release 17), TS 23.501 V17.0.0 (2021-03), which is superseded by 2021, Technical Specification Group Services and System Aspects; System architecture for the 5G System (5GS); Stage 2 (Release 18), TS 23.501 V18.2.2 (2023-07), the entire contents of each of which are hereby incorporated by reference. Further details on the O-RAN architecture can be found in O-RAN Alliance, “O-RAN Architecture Description,” version 7.00, October 2022, the entire contents of which is hereby incorporated by reference.

Aspects of RAN 109 and/or core 105 may be managed and/or monitored by SMO 112, non-RT RIC 122, and near-RT RIC 124. In some examples, SMO 112, non-RT RIC 122, and near-RT RIC 124 may be operated by the mobile network operator providing 5G services to a tenant. SMO 112 can orchestrate and control management and automation aspects of RAN 109 (e.g., network slicing, management, and orchestration of O-Cloud, etc.). Further, SMO 112 may control aspects of non-RT RIC 122 and near-RT RIC 124. Non-RT RIC 122 can provide non-real-time (e.g., greater than one second) control and optimization of RAN elements and resources such as RUs, DUs, and CUs, workflow management, and policy-based control of applications and features of near-RT RIC 124. Near-RT RIC 124 can provide near-real-time (e.g., milliseconds) control and optimization of RAN elements and resources via fine-grained data collection and actions. As further described in FIG. 1B, non-RT RIC 122 and near-RT RIC 124 may deploy as a highly scalable, microservices based containerized architecture. In some examples, near-RT RIC 124 may be located within an edge or regional cloud.

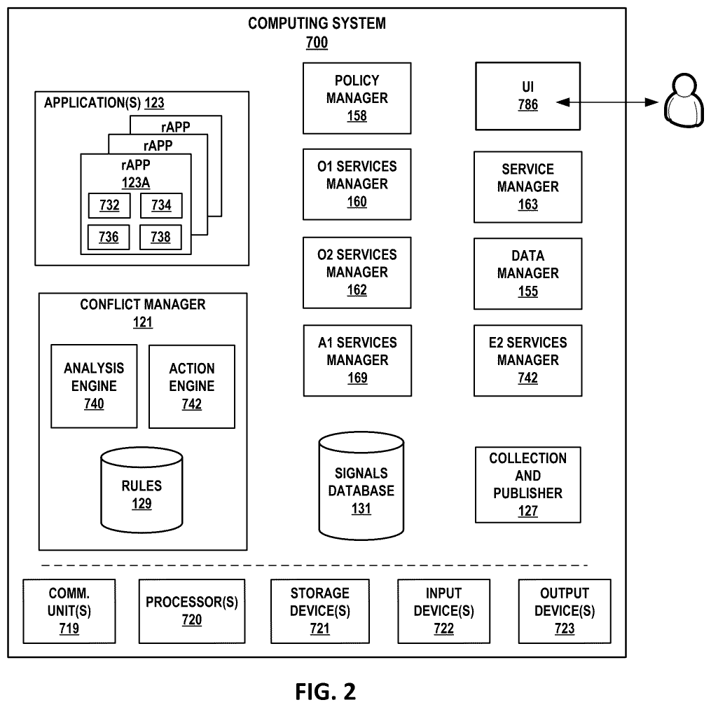

Non-RT RIC 122 may onboard one or more applications, e.g., applications 123 (e.g., rApps of FIG. 1B) that manage non-real time events within non-RT RIC 122, such as applications that do not require response times of less than one second. Applications 123 may leverage the functionality exposed via the non-RT RIC framework of non-RT RIC 122. Applications 123 may be used to control and manage RAN elements and resources, such as near-RT RIC 124, RAN nodes, and/or resources in the O-RAN cloud. Applications 123 may also utilize network data, performance metrics, and subscriber data to provide recommendations for network optimization and operational guidance (e.g., policies) to one or more applications of near-RT RIC 124. Near-RT RIC 124 may onboard one or more applications, e.g., applications 125 (e.g., xApps of FIG. 2) that manage near-real time events within near-RT RIC 124. Applications 125 may leverage the functionality exposed via the near-RT RIC framework of near-RT RIC 124. Near-RT RIC 124 may enforce policies received from applications 123 of non-RT RIC 122 and may provide policy feedback to non-RT RIC 122. Although illustrated as within non-RT RIC 122, any one or more of applications 123 may be executed by a third party, separate from non-RT RIC 122. Likewise, although illustrated as within near-RT RIC 124, any one or more of applications 125 may be executed by a third party, separate from near-RT RIC 124. Although shown as separate from non-RT RIC 122, applications 123 may in some cases include conflict manager 121 and other components that support conflict manager 121, as described elsewhere in this document.

Non-RT RIC 122 may provide services using A1, O1, and O2 interfaces. An A1 interface connects the non-RT RIC 122 and near-RT RIC 124. Non-RT RIC 122 may perform services via the A1 interface, such as policy management services (e.g., creation and update of a policy), ML model management services, and/or enrichment information services. Services performed via the A1 interface are referred to herein as “A1 services.” An O1 interface may include an interface that connects SMO 112 with O-RAN managed elements, such as near-RT RIC 124 and/or RAN nodes (e.g., O-RAN centralized unit (O-CU), O-RAN distributed unit (O-DU)). Non-RT RIC 122 may perform services via the O1 interface, such as configuration management services and performance management services of O-RAN managed elements (e.g., operation and maintenance (OAM) services), fault supervision, file management, heartbeat, trace, physical network function (PNF) discovery, software management, etc.). Services performed via the O1 interface are referred to herein as “O1 services.” An O2 interface may include an interface that connects SMO 112 to resources of the ORAN O-Cloud. The O-Cloud may comprise of one or more physical infrastructure nodes that host O-RAN functions (e.g., virtual network functions), the supporting software components, and the appropriate management and orchestration functions. Non-RT RIC 122 may perform services via the O2 interface, such as services that provide infrastructure management and/or network function deployment of the resources in the O-Cloud (e.g., discovery and administration of O-Cloud resources; Scale-In, Scale-Out of cloud/deployments; Fault, Configuration, Accounting, Performance, and Security (FCAPS) of cloud/deployments, software management of cloud platform/deployments; create/delete deployment and associated allocated O-Cloud resources). Services performed via the O2 interface are referred to herein as “O2 services.” Non-RT RIC 122 may also perform other functions and services, such as service management and exposure (SME) services (e.g., registration of a service, update of a service registration), data management and exposure (DME) services, AI/ML services, or the like.

In some instances, functions and/or services (e.g., A1 services, O1 services, O2 services, etc.) provided by non-RT RIC 122 may be in conflict. Besides services associated with different interfaces and functions associated with core network functions or RAN functions, “services” as referred to herein may also include higher order use cases or goals, such as Energy Savings mode or Slice Service Level Agreement (SLA) assurance.

Some conflicts may be observed directly by the framework functions (referred to herein as a “direct conflict”). For example, two or more applications 123 may request different settings for the very same parameters of a target (e.g., a first application requests for a first priority of a network slice, whereas a second application requests for a second, different priority for the same network slice). A target may be a configurable parameter, setting, object, or resource of the RAN, such as a priority, a policy, a network slice or network slice parameter, etc. As another example, an application may perform a change that conflicts with a running configuration from a previous request of the same or another application. As another example, an application may perform a change that exceeds the limitation of the target or RAN. Direct conflicts can be observed directly by network system 100 control plane components. Direct conflicts can be observed between rApps or between xApps but generally not between rApps and xApps.

In some examples, some conflicts may not be observed directly, but dependence among the parameters and resources that the applications are targeting can be observed (referred to herein as an “indirect conflict”). For example, an application may perform a change that creates a system impact which is equivalent to a change performed by another application (e.g., applications performing different actions, but impacts to the system are equivalent). Indirect conflicts cannot be observed directly, nevertheless, some dependence among the parameters and resources that the rApps or xApps target can be observed. Indirect conflict between rApps and xApps are further challenges.

The above are example types of conflicts and are merely some examples of the types of conflicts. Other conflicts may be observable by network system 100 control plane components, such as conflicts that are not observed directly of where the dependency between applications is not obvious (referred to as an “implicit conflict”). Implicit conflicts cannot be observed directly, for even the dependence between xApps or between rApps is not obvious. Different use cases may optimize different functions/different parameters and may have implicit/unwanted/adverse side effects to other use cases. Implicit conflicts between rApps and xApps may be the most challenging case.

There are different possible approaches for conflict mitigation. Direct conflicts typically can be mitigated by pre-action coordination. Indirect conflicts may be resolved by post-action verification. Based on observations of the network state, which may include network resource model parameters, a system may decide on potential corrections, e.g., rolling back one of the xApp or rApp actions. Implicit conflicts are the most difficult to mitigate since these dependencies are difficult or impossible to observe and therefore hard to model in any mitigation scheme. In some cases, it may be possible to design around such conflicts by ensuring that use cases (xApps or rApps) target different parameters, thus falling back to post-action verification.

In accordance with the techniques described in this disclosure, network system 100 provides an extensible conflict management and mitigation framework for non-RT RIC 122 that manages RAN 109. In this example, SMO 112 includes a conflict manager 121 configured to provide conflict management for one or more non-RT RIC 122 functions or services. As illustrated in FIG. 1A, conflict manager 121 may be a component of SMO 112 for an associated enterprise, mobile network operator, and/or provider associated with RAN 109; conflict manager 121 may also or alternatively be a separate system associated with a third party, which may be, e.g., an enterprise, mobile network operator, and/or provider. Conflict manager 121 may also or alternatively be a component of non-RT RIC 122 or near-RT RIC 124. Conflict manager 121 may be pluggable within an extensible platform, such as non-RT RIC 122 and/or SMO 112, as a pluggable instance. Conflict manager 121 may include an artificial intelligence (AI)/machine learning (ML) model and apply the model to select signals to subscribe to as well as conflict mitigation strategies. Conflict manager 121 may be implemented, for example, by one or more microservices.

Non-RT RIC 122 stores signals, which can include messages communicated via interfaces; events reported via interfaces; and/or actions directed and optionally reported via the interfaces, where the interfaces may include, for examples, the O1, A1, O2, and E2 interfaces as defined by 3GPP and O-RAN standards. Non-RT RIC 122 may store such signals in association with network data representative of the state of the mobile network at the time of a signal. Network data can include telemetry information, network resource model data, or other data indicative of network configuration state, operational state, and/or network performance. In this way, non-RT RIC 122 captures events/messages/actions of applications 123 (e.g., rApps and/or xApps) over the O1, A1, O2 and E2 interfaces. Conflict manager 121 obtains signals (and optionally associated network data) stored by non-RT RIC 122 determined as useful for conflict management and mitigation.

Based on the obtained data, conflict manager 121 may identify conflicts. Conflict manager 121 may then provide feedback and direct or otherwise communication with non-RT RIC 122 to mitigate and/or manage the identified conflicts.

Additional details for handling conflicts are found in U.S. Patent Publication 2024/0163649, published May 16, 2024, “Conflict Management of Functions and Services,” which is incorporated by reference herein in its entirety.

FIG. 1B is a block diagram illustrating example details of the non-RT RIC 122 of SMO system 112 of FIG. 1A. In the example illustrated in FIG. 1B, SMO 112 may include non-RT RIC 122, one or more AI/ML models 142, one or more functions 144 (e.g., NSSMF, NFMF, and other functions), and open interfaces, such as O1 termination interface 168 and O2 termination interface 169. SMO 112 may manage non-RT RIC 122, near-RT RIC 124, O-RAN managed elements (e.g., centralized unit (O-CU) 146, O-RAN decentralized unit (O-DU) 148 of one or more base stations), and resources in O-RAN cloud 150.

Near-RT RIC 124 can provide near-real-time (e.g., milliseconds) control and optimization of RAN elements and resources, such as O-CU 146 and/or O-DU 148, via fine-grained data collection and actions performed via E2 interface 165. For example, near-RT RIC 124 may onboard one or more applications (e.g., xApps) that provide near-real time control of RAN elements and their resources.

Non-RT RIC 122 may provide non-real-time (e.g., greater than one second) control and optimization of RAN elements and resources such as RUs, DUs, and CUs, workflow management, and policy-based control of applications and features of near-RT RIC 124.

Non-RT RIC 122 may be deployed as a highly scalable, microservices based containerized architecture. In this example, non-RT RIC 122 may onboard, deploy, and/or terminate one or more applications, e.g., rApp 123A through rApp 123N (collectively “applications 123”). Applications 123 may represent applications that leverage the functionality exposed via the framework of non-RT RIC 122. Applications 123 may provide non-RT RIC 122 with non-real time (e.g., greater than one second) control of RAN elements and their resources. Applications 123 may provide services for radio resource management, higher layer procedure optimization, policy optimization, and providing guidance, parameters, policies, and AI/ML models to support the operation of RAN functions.

For example, applications 123 may provide A1 services that provide and facilitate RAN operations and optimization of near-RT RIC 124, such as providing operational guidance (e.g., policies), enrichment information (e.g., forecasts), and AI/ML services. A1 services may include policy management services such as creating, updating, and/or deleting of A1 policies; receiving policy feedback; querying policy types, identifiers, and status; defining which policy types are supported by near-RT RIC 124; and registering applications (xApps) of near-RT RIC 124 to specific policy types. A1 services may include enrichment information services, such as providing data for model training of AI/ML models, such as forecasts and/or data analytics.

Applications 123 may provide O1 services that provide configuration management or performance management of O-RAN managed entities, such as near-RT RIC 124 and/or RAN nodes, e.g., O-CU 146, O-DU 148 (also referred to herein as “E2 nodes”). O1 services may provide configuration management services to create, update, and/or delete configurations to O-RAN managed entities. For example, configuration management services may include provisioning operations (e.g., for NSS and NF provisioning) to create a managed object instance (MOI), obtain MOI attributes, modify MOI attributes, and/or delete the MOI. O1 services may also provide performance management services that monitor the status of elements or components in the O-RAN managed entities. For example, non-RT RIC 122 may create, modify, or delete performance management jobs to receive performance metrics, or send heartbeat messages to monitor the status and/or availability of services of RAN nodes or to send trace messages to monitor link failures. O1 services may also provide file management, such as to push files to the RAN nodes (e.g., software updates, beamforming configuration files, ML models, security certificates, etc.). As another example, O1 services via O1 interface 166 may be used to configure network elements, including those modeled according to information models defined in for New Radio Network Resource Model (NR NRM), as described in 3GPP TS 28.541, V18.8.0, June, 2024, “3^{rd} Generation Partnership Project; Technical Specification Group Services and System Aspects; Management and orchestration; 5G Network Resource Model (NRM); Stage 2 and stage 3 (Release 18),” which is incorporated herein by reference in its entirety.

Applications 123 may provide O2 services that provide infrastructure management and/or network function deployment of resources in O-RAN cloud 150 (also referred to herein as “O-Cloud 150”). O2 services may provide discovery and administration of O-Cloud resources; Scale-In, Scale-Out of cloud/deployments (e.g., deploying resources with more or less processors); FCAPS of cloud/deployments, software management of cloud platform/deployments; create/delete deployment and associated allocated O-Cloud resources.

Applications 123 may provide service management and exposure (SME) services, data management and exposure (DME) services, and/or other services. SME services may provide services that enable services provided over an internal interface (R1 interface 154) of non-RT RIC 122 and their exposure and extensibility through services including bootstrap, service registration/deregistration or updates to service registration, service discovery or notification, heartbeat, authentication, authorization, etc. Data management and exposure (DME) services may include services that manage data and their exposure between applications 123. For example, applications 123 may have different functions, such as application 123A configured to collect and analyze data, application 123B configured to generate an ML model based on the results of the analysis, and application 123N configured to make a prediction or inference using the ML model and/or to generate controls for RAN nodes based on the prediction or inference. DME services may manage the data shared between applications 123, such as the collection of data, the processing of the data, and/or the advertisement of the data.

As already noted, applications 123 may include conflict manager 121, as well as collection and publisher service 127.

Non-RT RIC 122 may include one or more managers to manage the RAN by, e.g., managing A1 services, O1 services, O2 services, SME, DME services, and other services. For example, non-RT RIC 122 may include a policy manager 158, O1 services manager 160, O2 services manager 162, A1 services manager 169, service manager 163, data manager 155, and conflict manager 121. Non-RT RIC 122 may include other managers, such as an application manager and an application on-boarder, that are configured to manage the installation and deployment of applications 123. The A1, O1, O2, and E2 services are available via respective A1, O1, O2, and E2 interfaces, and each of A1 services manager 169, O1 services manager 160, O2 services manager 162, and E2 services manager 742 manages the RAN via the corresponding one of the A1, O1, O2, and E2 interfaces.

Policy manager 158 is configured to control the deployment of policies (e.g., A1 services). For example, in response to receiving requests for A1 services from applications 123 via R1 interface 154, R1 interface 154 sends the requests to policy manager 158 via message bus 151. Policy manager 158 may process the A1 services and may send the A1 services to A1 termination 156 via message bus 151, which provides the A1 services to near-RT RIC 124 via A1 interface 164. In some examples, the A1 interface may implement an A1AP application protocol based on the O-RAN specifications.

O1 services manager 160 is configured to control the deployment of O1 services for monitoring the performance of near-RT RIC 124 and/or RAN nodes (e.g., O-CU 146, O-DU 148). For example, in response to receiving requests for O1 services for monitoring the performance of near-RT RIC 124 from applications 123 via R1 interface 154, R1 interface 154 sends the requests to O1 services manager 160 via message bus 151. O1 services manager 160 may process the O1 services and may send the O1 services to O1 termination 168, which provides the O1 services to near-RT RIC 124 via O1 interface 166. In some examples, the O1 interface may implement REST/HTTPS APIs and/or NETCONF.

O1 services manager 160 is additionally, or alternatively, configured to control the deployment of O1 services for the configuration of near-RT RIC 124 and/or RAN nodes. For example, in response to receiving requests for O1 services for the configuration of near-RT RIC 124 from applications 123 via R1 interface 154, R1 interface 154 sends the requests to O1 services manager 160. O1 services manager 160 may process the O1 services and may send the O1 services to O1 termination 168, which provides the O1 services to near-RT RIC 124 via O1 interface 166.

O2 services manager 162 may be configured to control the deployment of O2 services for monitoring the performance of resources of O-Cloud 150. For example, in response to receiving requests for O2 services for monitoring the performance of resources within 0-Cloud 150 via R1 interface 154, R1 interface 154 sends the request to O2 services manager 162. O2 services manager 162 may process the O2 services and may send the O2 services to O2 termination 169, which provides the O2 services to resources of O-Cloud 150 via O2 interface 167.

O2 services manager 162 may additionally, or alternatively, be configured to control the deployment of O2 services for the configuration of resources of O-Cloud 150. For example, in response to receiving requests for O2 services for configuring resources within O-Cloud 150 from applications 123 via R1 interface 154, R1 interface 154 sends the requests to O2 services manager 162. O2 services manager 162 may process the O2 services and may send the O2 services to O2 termination 169, which provides the O2 services to resources of O-Cloud 150 via O2 interface 167.

A1 services manager 169 in non-RT RIC 122 provides control and coordination for A1 interface 164, which connects non-RT RIC 122 to near-RT RIC 124. A1 services manager 169 may translate high-level policy and intent from non-RT RIC 122 into standardized A1 messages that can be enforced within the RAN. A1 services manager may handle feedback and status reports from near-RT RIC 124, ensuring closed-loop communication between intent-setting and execution. In this way, A1 services manager 169 may enable policy-driven optimization, machine learning model management, and enrichment information exchange across the RAN.

Near-RT 124 may also include an A1 services manager, which terminates and interprets A1 messages sent by non-RT RIC 122. The A1 services manager for near-RT RIC 124 may receive policies, machine learning models, and enrichment information, and translates these into actionable configurations for RAN control functions. The A1 services manager for near-RT RIC 124 may also report execution status, policy feedback, and outcomes to non-RT RIC 122, maintaining alignment with higher-level intent. In this way, The A1 services manager for near-RT 124 operates as a gateway to ensure near-RT RIC 124 enforces external guidance while retaining its own low-latency control capabilities.

In some examples, R1 interface 154 also exposes applications 123 to SME services, DME services, and/or other services. For example, in response to receiving requests for SME services from applications 123 via R1 interface 154, R1 interface 154 sends the requests to service manager 163. Service manager 163 may process the SME services (e.g., register/update a service) and may send the SME services to R1 termination 152, which provides the SME services to applications 123 via R1 interface 154 (e.g., sending response to application regarding service registration, update, or discovery). Similarly, in response to receiving requests for DME services from applications 123 via R1 interface 154, R1 interface 154 sends the requests to data manager 155. Data manager 155 may process the DME services and may send the DME services to R1 termination 152, which provides the DME services to applications 123 via R1 interface 154 (e.g., sending data from application configured as a data producer to application configured as a data consumer).

R1 interface 154 may also expose applications 123 to slice subnet management services, such as RAN NSSMF interfaces to retrieve slice service level agreements (SLAs) and slice topologies, and/or slice management, SLA, and slice performance management notifications to applications 123.

In accordance with the techniques described in this disclosure, conflict manager 121 and collection and publisher 127 are services for facilitating extensible conflict management. Signals database 131 stores signals data relating to signals, optionally in association with network data representative of the state of the mobile network at the time of a signal. Signals database 126 may represent a redis database, a SQL database, another database, a file, a table, a log, or other data structure stored to a storage medium. Conflict manager 121 and collection and publisher service 127 may be microservices or other containerized applications, virtual machines, processes, and/or other type of deployable software.

In the illustrated example, non-RT RIC 122 may monitor signals exchanged among managers/services and applications 123 via message bus 151 and additionally sends the signals to collection and publisher service 127. Collection and publisher service 127 collects these necessary O1, A1, O2 and E2 interface signals from the RIC, combining them and storing all of these signals, along with other applicable state information about the network, to signals database 131.

Collection and publisher service 127 provide these signals using (optionally open) interfaces to authorized conflict manager 121 or other applications that may be part of the non-RT RIC 122, or to plugins for third-party applications. The open interface may enable future replacements/upgrades of conflict manager 121 to facilitate ongoing improvements, including AI/ML-based conflict management and mitigation, and a dynamic and extensible approach to conflict management and mitigation. Although only one conflict manager 121 is shown, additional conflict managers, e.g., associated with other operators or users, may be authorized to receive the signals for analysis and/or conflict mitigation and managements. Conflict manager 121 may subscribe to collection and publisher service 127 to receive signals. The subscription framework may be, e.g., a pub/sub framework whereby collection and publisher service 127 publishes selected signals and associated network data to topics that can be subscribed to by conflict manager 121, a message bus, or other framework. Conflict manager 121 may subscribe to specified subsets of the signals, such as signals relating to a particular O1, A1, O2, or E2 interface, or to signals relating to particular network elements or information models. Conflict manager 121 may subscribe by sending a request to collection and publisher service 127 for the selected signals (i.e., the specified subsets of signals), which publishes the signals for use by conflict manager 121.

Conflict manager 121 processes signals obtained from signals database 131 and, upon detecting a conflict, conflict manager interacts with non-RT RIC 122 regarding possible conflict avoidance and mitigation strategies. For non-RT RIC 122, collection and publisher service 127 and conflict manager 121 may interact via (optionally open) interfaces to enable future replacements of these services/applications. An open interface may be one implemented according to an open standard, or a non-proprietary interface. Conflict manager 121 may implement AI/ML-based conflict management and mitigation strategies.

For example, conflict manager 121 is configured to provide conflict management for services of the corresponding interface(s) of non-RT RIC 122. While conflict manager 121 is illustrated as a separate microservice of non-RT RIC 122, in some examples, the techniques described herein may be performed by one or more other microservices, such as policy manager 158, O1 services manager 160, O2 services manager 152, service manager 163, and/or data manager 155. In this example, in response to receiving a request of an A1 service, O1 service, O2 service, or other services (e.g., SME, DME), R1 termination 152 may send a message via message bus 151 to conflict manager 121 to perform conflict management of the A1 service, O1 service, O2 service, or other services.

As one example, conflict manager 121 may provide conflict management for A1 services to create, modify, or delete a policy. A policy may be a declarative policy expressed using formal statements that enable non-RT RIC 122 to guide the near-RT RIC 124 function. As one example, a policy may comprise a scope identifier and one or more policy statements. A scope identifier may represent what the policy statements are to be applied on (e.g., cells, network slices, UEs, UE groups, QoS flows, etc.). The one or more policy statements may specify policy goals, such as policy objectives (e.g., QoS, QoE, UE level, slice SLA objectives) and policy resources (e.g., resource usage for the policy). Additional examples of policy management services are described in O-RAN.WG2.A1GAP-v03.000; “O-RAN Working Group 2; A1 interface: General Aspects and Principles,” the entire contents of which is incorporated by reference herein. An example of a policy created by a first application (e.g., rApp 123A) is shown below:

Example A1 policy:

```
{
  “scope”: {
      “sliceId”: {
          “sst”: 3, “sd”: “456DEF”,
          “plmnId”: { “mcc”:”248”, “mnc”:”35” }
      }
  },
  “sliceSlaObjectives”: {
      “maxNumberOfUes”: 10000,
      “maxNumberOfPduSessions”: 800 },
  “sliceSlaResources”: {
      “cellIdList”: [
          {“plmnId”: {“mcc”: “248”,”mnc”: “35”}, “cId”: {“ncI”: 1}},
          {“plmnId”: {“mcc”: “248”,”mnc”: “35”}, “cId”: {“ncI”: 2}}
        ]
    }
}
```

The scope of the above policy includes a slice with slice SLA objectives specifying the maximum number of UEs (e.g., 10000) and maximum number of PDU sessions (e.g., 800), and slice SLA resources specifying target cells in near-RT RIC domain includes certain types of cells.

In some instances, a second application (e.g., rApp 123B) may request to create a policy that conflicts with the policy of the first application. For example, an example of a policy of the second application (e.g., rApp 123B) is shown below:

Example A1 policy:

```
{
  “scope”: {
      “sliceId”: {
          “sst”: 3, “sd”: “456DEF”,
          “plmnId”: { “mcc”:”248”, “mnc”:”35” }
      }
  },
  “sliceSlaObjectives”: {
      “maxNumberOfUes”: 30000,
      “maxNumberOfPduSessions”: 800 },
  “sliceSlaResources”: {
      “cellIdList”: [
          {“plmnId”: {“mcc”: “248”,”mnc”: “35”}, “cId”: {“ncI”: 1}},
          {“plmnId”: {“mcc”: “248”,”mnc”: “35”}, “cId”: {“ncI”: 2}}
        ]
    }
}
```

Conflict manager 121 may determine whether there are conflicts between the overlapping policies of applications 123 (rApps), for example, by determining whether the overlapping policies include contradicting statements (e.g., objective/resource statements). In this example, conflict manager 121 may determine that there is a conflict between the objective statements (e.g., policy of the first application (rApp 123A) that specifies a maximum number of UEs as 10000 and the policy of the second application (e.g., rApp 123B) that specifies a maximum number of UEs as 30000).

Based on the determination that there is a conflict between the objective statements of the policy of application 123A and the objective statements of the policy of application 123B, conflict manager 121 may instruct non-RT RIC 122 to perform an action to address the conflict. In some examples, conflict manager 121 may determine which of the conflicting policies to implement based on one or more conflict management rules. As one example, conflict manager 121 may implement a first come, first served rule. In this example, non-RT RIC 122 may implement the policy of the first application if the request to create the policy of the first application precedes the request to create the policy of the second application. Alternatively, or additionally, conflict manager 121 may implement a priority-based overriding rule where the policy of an application with a higher priority is implemented. For example, conflict manager 121 may implement the policy of the second application based on the second application having a higher priority than the first application. In some examples, conflict manager 121 may override a policy with a general scope with a policy specifying a narrower scope. For example, non-RT RIC 122 may implement a policy for a UE specific performance target over a policy specifying performance target for all UEs. In some examples, an operator may configure the conflict management rule to apply for each policy statement. For example, the operator may configure the implementation of a first conflict management rule in response to the determination of a conflict with a first policy statement and configure the implementation of a second conflict management rule that is different than the first conflict management rule in response to the determination of a conflict with a second policy statement. In some examples, parameters of a network resource may be classified into different types, such as an Information Object Class (IOC), ProxyClass, and DataType parameters. An IOC describes the information that can be used in management interfaces. The IOC includes attributes that represent the various properties of the IOC. Managed object instances (MOIs) may be the instantiated objects of IOCs when performing configuration management. In some examples, a distinguished name (DN) is used to uniquely identify an MOI within a name space. In these examples, non-RT RIC 122 may apply a conflict management rule based on parameter or based on parameter and parameter type. For example, conflict manager 121 may determine whether a target distinguished name (DN) of a first request overlaps with a target DN of a second request and determine whether an MOI and attribute of the first request overlaps with an MOI and attribute of the second request.

In some examples, non-RT RIC 122 may provide operator-configurable conflict management rules (e.g., user can specify the type of conflict management rule to apply).

In some examples, an application (e.g., rApp A) may request for policy guidance before requesting to create the policy. In these examples, conflict manager 121 may, in response to receiving a request for conflict guidance for a policy, check the target near-RT RIC 124 and/or check for contradicting statements of overlapping policies, validating limits (e.g., whether limits are exceeded or not), and/or conflicting indirect actions. Conflict manager 121 may provide a response (guidance response) including an indication of whether the policy creates a conflict or not. In some examples, conflict manager 121 may provide a response including one or more recommendations to resolve the conflict (e.g., recommendation to resolve the contradicting statements). Alternatively, or additionally, conflict manager 121 may provide a response including information on the cause of the conflict, such as a list of contradicting statements (e.g., contradicting objective/resource parameters).

As another example, conflict manager 121 may provide conflict management for O1 services to create configuration requests for managed object instances (MOI) of O-RAN managed elements (e.g., near-RT RIC 124, O-CU 146, O-DU 148). In this example, a first application (e.g., rApp 123A) may have previously issued a configuration request to create an MOI of O-DU 148. Conflict manager 121 may determine whether a configuration request of a second application (e.g., rApps 123B) to create an MOI of O-DU 148 conflicts with the previous configuration request of the first application to create the MOI of O-DU 148. Based on the determination of whether there is a conflict between the configuration request of the first application and the configuration request of the second application, conflict manager 121 may instruct non-RT RIC 122 to perform an action to address the conflict. Conflict manager 121 may determine which of the conflicting configuration requests to implement based on one or more conflict management rules (e.g., first come, first served; priority-based overriding; scope; etc.), as described above.

As another example, conflict manager 121 may provide conflict management for O2 services to deploy (e.g., provision configuration changes to resources of O-Cloud 150. For example, a first application (e.g., rApp 123A) may have previously issued a configuration request to scale up the number of processors of a resource of O-Cloud 150. Conflict manager 121 may determine whether a configuration request by a second application (e.g., rApp 123B) to provision a configuration change to the resource conflicts with the previous configuration of the resource as requested by the first application. As one example, if the second application requests to configure the resource of O-Cloud 150 to reduce the number of processors to save energy, conflict manager 121 may determine that there is a conflict if the configuration request of the first application configures the resource to increase the number of processors for scalability. Based on the determination that there is a conflict between the configuration requests of the resource of O-Cloud 150, conflict manager 121 may instruct non-RT RIC 122 to perform an action to address the conflict. Conflict manager 121 may determine which of the conflicting configuration requests to implement based on one or more conflict management rules (e.g., first come, first served; priority-based overriding; scope; etc.), as described above.

In some examples, conflict manager 121 applies a rule-based scheme to identify and mitigate or manage conflicts. Conflict manager 121 in such examples includes rules 129. Each of rules 129 may specify one or more of the following: (1) the signals that are to be collected, (2) priorities among functions and services to indicate to conflict manager 121 which of the functions and services to attenuate in the event of a conflict, (3) relevant services of non-RT RIC 122 to invoke to address conflicts, or (4) information models and model parameter values to use to address particular conflicts.

A user using a user interface to configure conflict manager 121 (or indirectly via SMO 112 or non-RT RIC 122) may set rules 129.

FIG. 2 is a diagram illustrating an example computing system in detail, in accordance with techniques of this disclosure. In this example of FIG. 2, computing system 700 may implement, for example, a non-real time RIC, such as non-RT RIC 122 of FIGS. 1A-1B or may implement a near-RT RIC, such as near-RT RIC 124 of FIGS. 1A-1B. Conflict manager 121, signals database 131, and collection and publisher service 127 may be part of the RIC or deployed to a separate computing system and communicating via the RIC via a network.

Computing system 700 includes one or more processors 720, one or more input devices 722, one or more output devices 723, one or more communication units 719, and one or more storage devices 721. In some examples, computing system 700 is a cloud computing system, server farm, and/or server cluster (or portion thereof) that provides services to client devices and other devices or systems. In other examples, computing system 700 may be implemented through one or more virtualized compute instances (e.g., virtual machines, containers) of a data center, cloud computing system, server farm, and/or server cluster.

One or more of the devices, modules, storage areas, or other components of computing system 700 may be interconnected to enable inter-component communications (physically, communicatively, and/or operatively). In some examples, such connectivity may be provided by communication channels, a system bus (e.g., message bus 151 of FIG. 1B), a network connection, an inter-process communication data structure, or any other method for communicating data.

One or more processors 720 of computing system 700 may implement functionality and/or execute instructions associated with conflict management for a non-RT RIC, near-RT RIC, or associated with one or more modules illustrated herein and/or described herein, including applications 123, policy manager 158, O1 services manager 160, O2 services manager 162, service manager 163, data manager 155, and conflict manager 121. One or more processors 720 may be, may be part of, and/or may include processing circuitry that performs operations in accordance with one or more aspects of the present disclosure. Examples of processors 720 include microprocessors, application processors, display controllers, auxiliary processors, one or more sensor hubs, and any other hardware configured to function as a processor, a processing unit, or a processing device. Computing system 700 may use one or more processors 720 to perform operations in accordance with one or more aspects of the present disclosure using software, hardware, firmware, or a mixture of hardware, software, and firmware residing in and/or executing at computing system 700. Any one or more of applications 123, policy manager 158, O1 services manager 160, O2 services manager 162, A1 services manager 169, E2 services manager 742, service manager 163, data manager 155, conflict manager 121, signals database 131, or collection and publisher service 127 may be hosted by a cloud provider or other third-party. Computing system 700 may include a subset of the above-listed components. For example, a non-RT may not include E2 services manager 742, while a near-RT RIC may not include O2 services manager 162.

E2 services manager 742 in near-RT RIC 124 is responsible for orchestrating interactions over E2 interface 165, which connects the near-RT RIC to RAN nodes such as O-DUs, O-CUs, and gNBs. E2 services manager 742 establishes and maintains secure, reliable E2 connections, handling registration of nodes, session management, and protocol compliance with the E2 Application Protocol (E2AP). E2 services manager 742 may ensure that near-RT RIC 124 can dynamically subscribe to telemetry streams, receive performance and state information from RAN nodes, and interpret that data in near real time. This flow of information allows the near-RT RIC to continuously monitor the health, load, and performance of the RAN for optimized decision-making for managing the RAN.

E2 services manager 742 may enable the enforcement of control actions back into the RAN by distributing instructions through E2 Service Models (E2SMs). These models define how policies, optimization directives, and configuration changes are expressed for different RAN functions, such as traffic steering, mobility management, or QoS adjustments. E2 services manager 742 may act as the translation and dispatch layer, ensuring that intent from rApps 123 and higher-level RIC logic is properly conveyed to and executed by RAN nodes. By coordinating both telemetry intake and control dissemination, E2 services manager 742 may facilitate delivery by near-RT RIC 124 of fine-grained, low-latency, and policy-driven optimization of the RAN.

One or more communication units 719 of computing system 700 may communicate with devices external to computing system 700 by transmitting and/or receiving data, and may operate, in some respects, as both an input device and an output device. In some examples, communication units 719 may communicate with other devices over a network. In other examples, communication units 719 may send and/or receive radio signals on a radio network such as a cellular radio network. In other examples, communication units 719 of computing system 700 may transmit and/or receive satellite signals on a satellite network such as a Global Positioning System (GPS) network. Examples of communication units 719 include a network interface card (e.g., an Ethernet card), an optical transceiver, a radio frequency transceiver, a GPS receiver, or any other type of device that can send and/or receive information. Other examples of communication units 719 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input devices 722 may represent any input devices of computing system 700 not otherwise separately described herein. One or more input devices 722 may generate, receive, and/or process input from any type of device capable of detecting input from a human or machine. For example, one or more input devices 722 may generate, receive, and/or process input in the form of electrical, physical, audio, image, and/or visual input (e.g., peripheral device, keyboard, microphone, camera).

One or more output devices 723 may represent any output devices of computing system 700 not otherwise separately described herein. One or more output devices 723 may generate, receive, and/or process input from any type of device capable of detecting input from a human or machine. For example, one or more output devices 723 may generate, receive, and/or process output in the form of electrical and/or physical output (e.g., peripheral device, actuator).

One or more storage devices 721 within computing system 700 may store information for processing during operation of computing system 700. Storage devices 721 may store program instructions and/or data associated with one or more of the modules described in accordance with one or more aspects of this disclosure. One or more processors 720 and one or more storage devices 721 may provide an operating environment or platform for such modules, which may be implemented as software, but may in some examples include any combination of hardware, firmware, and software. One or more processors 720 may execute instructions and one or more storage devices 721 may store instructions and/or data of one or more modules. The combination of processors 720 and storage devices 721 may retrieve, store, and/or execute the instructions and/or data of one or more applications, modules, or software. Processors 720 and/or storage devices 721 may also be operably coupled to one or more other software and/or hardware components, including, but not limited to, one or more of the components of computing system 700 and/or one or more devices or systems illustrated as being connected to computing system 700.

In some examples, one or more storage devices 721 are temporary memories, meaning that a primary purpose of the one or more storage devices is not long-term storage. Storage devices 721 of computing system 700 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Storage devices 721, in some examples, also include one or more computer-readable storage media. Storage devices 721 may be configured to store larger amounts of information than volatile memory. Storage devices 721 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories.

Computing system 700 may provide conflict management for applications 123. As described above, applications 123 may manage non-real time events within non-RT RIC 122, such as applications that do not require response times of less than one second. Applications 123 may leverage the functionality exposed via a non-RT RIC framework of computing device 700. Applications 123 may be used to control and manage RAN elements and resources, such as a near-RT RIC, RAN nodes, and/or resources in the O-RAN cloud. Applications 123 may provide one or more services that are performed using interfaces of computing system 700 (e.g., A1 interface, O1 interface, O2 interface, etc.). For example, applications 123 may include services such as policies 732 for a near-RT RIC, configuration instructions 734 for O-RAN managed elements, performance jobs 736 for O-RAN managed elements, services for managing the services and/or data 738, etc.

Computing system 700 may include one or more modules or units configured to perform one or more services or functions of applications 123, such as policy manager 158, O1 services manager 160, O2 services manager 162, service manager 163, data manager 155, and conflict manager 121, as described above.

For example, policy manager 158 is configured to control the deployment of policies (e.g., A1 services). For example, policy manager 158 may receive requests for A1 services from applications 123 (e.g., via R1 interface 154 of FIG. 1B), process the A1 services from applications 123, and perform the A1 services for a near-RT RIC using an A1 interface (e.g., A1 interface 164 of FIG. 1B). In some examples, the A1 interface may implement an A1AP application protocol based on the 3GPP framework.

O1 services manager 160 is configured to control the deployment of O1 services for monitoring the performance of O-RAN managed elements (e.g., near-RT RIC 124, O-CU 146, O-DU 148 of FIG. 1B). For example, O1 services manager 160 may receive requests for O1 services for monitoring the performance of the near-RT RIC from applications 123 (e.g., via R1 interface 154 of FIG. 1B), process the O1 services, and perform the O1 services for the O-RAN managed elements using an O1 interface (e.g., O1 interface 166 of FIG. 1B). In some examples, the O1 interface may implement REST/HTTPS APIs and/or NETCONF.

O1 services manager 160 is additionally, or alternatively, configured to control the deployment of O1 services for the configuration of near-RT RIC 124 and/or RAN nodes. For example, O1 services manager 160 may receive requests for O1 services for the configuration of O-RAN managed elements from applications 123 (e.g., via R1 interface 154 of FIG. 1B), process the O1 services, and may perform the O1 services for the O-RAN managed elements using an O1 interface (e.g., O1 interface 166 of FIG. 1B).

O2 services manager 162 may be configured to control the deployment of O2 services for monitoring the performance of resources of the O-RAN cloud. For example, O2 services manager 162 may receive requests for O2 services for monitoring the performance of resources within the O-RAN cloud (e.g., via R1 interface 154 of FIG. 1B), process the O2 services, and may perform the O2 services for the resources of the O-RAN cloud using an O2 interface (e.g., O2 interface 167 of FIG. 1B).

O2 services manager 162 may additionally, or alternatively, be configured to control the deployment of O2 services for the configuration of resources of the O-RAN cloud. For example, O2 services manager 162 may receive requests for O2 services for configuring resources within the O-RAN cloud from applications 123 (e.g., via R1 interface 154 of FIG. 1B), process the O2 services, and may perform the O2 services for the resources of the O-RAN cloud using an O2 interface (e.g., O2 interface 167 of FIG. 1B).

Service manager 163 is configured to manage services, such as registration of a service, update of a service registration, service discovery, etc. For example, service manager 163 may receive requests for SME services from applications 123 (e.g., via R1 interface 154 of FIG. 1B), perform the SME service (e.g., register/update a service) for one or more applications 123, and send a response to the one or more applications 123 using an R1 interface (e.g., R1 interface 154 of FIG. 1B).

Data manager 155 is configured to manage the data of applications 123. For example, data manager 155 may receive requests for DME services from applications 123 (e.g., via R1 interface 154 of FIG. 1B), perform the DME services (e.g., sending data from application configured as a data producer to application configured as a data consumer) for one or more applications 123, and send a response to the one or more applications 123 using an R1 interface (e.g., R1 interface 154 of FIG. 1B).

Computing system 700 includes conflict manager 121 configured to provide conflict management of services performed using interfaces of the non-RT RIC. In this example, conflict manager 121 includes an analysis engine 740, and action engine 742, and one or more conflict management rules 744.

In some examples, analysis engine 740 is configured to determine whether overlapping policies (e.g., where at least a portion of the scope of the policies overlap) include contradicting statements (e.g., objective/resource statements) of A1 services performed using the A1 interface. In some examples, analysis engine 740 is configured to determine whether requests to configure one or more O-RAN managed elements performed using the O1 interface or one or more resources of the O-RAN cloud performed using the O2 interface would cause a conflict (e.g., conflicting MOIs). In some examples, analysis engine 740 is configured to determine whether requests for performance jobs for one or more 0-RAN managed elements performed using the O1 interface or one or more resources of the O-RAN cloud performed using the O2 interface would cause a conflict (e.g., overlapping IOCs and attributes, contradicts attribute value changes, specify different data networks, etc.). In some examples, analysis engine 740 is configured to determine whether requests to manage services performed using the R1 interface would cause a conflict (e.g., conflict with previously registered services or previously implemented application).

In response to determining that the service has a conflict, action engine 742 is configured to address the determined conflict. For example, action engine 742 may implement the services based on one or more rules 129. In addition to or alternatively to the description above, rules 129 may include, for example, implementing a policy based on a first come, first served basis, implementing a policy from the application with a higher priority, implementing a policy based on scope of the policy, implementing a policy based on an IOC type or based on an IOC type and attribute of the IOC.

In some examples, a user may specify which of rules 129 to apply to address a conflict via user interface module (UI) 786, or to add or modify rules 129. UI module 786 can generate data indicative of various user interface screens that graphically depict the conflict management rules UI module 786 can output, e.g., for display by a separate display device, the data indicative of the various user interface screens. UI module 786 can also output, for display, data indicative of graphical user interface elements that solicit input. Input may be, for example, a conflict management rule to be applied to a particular service, queries, or other input.

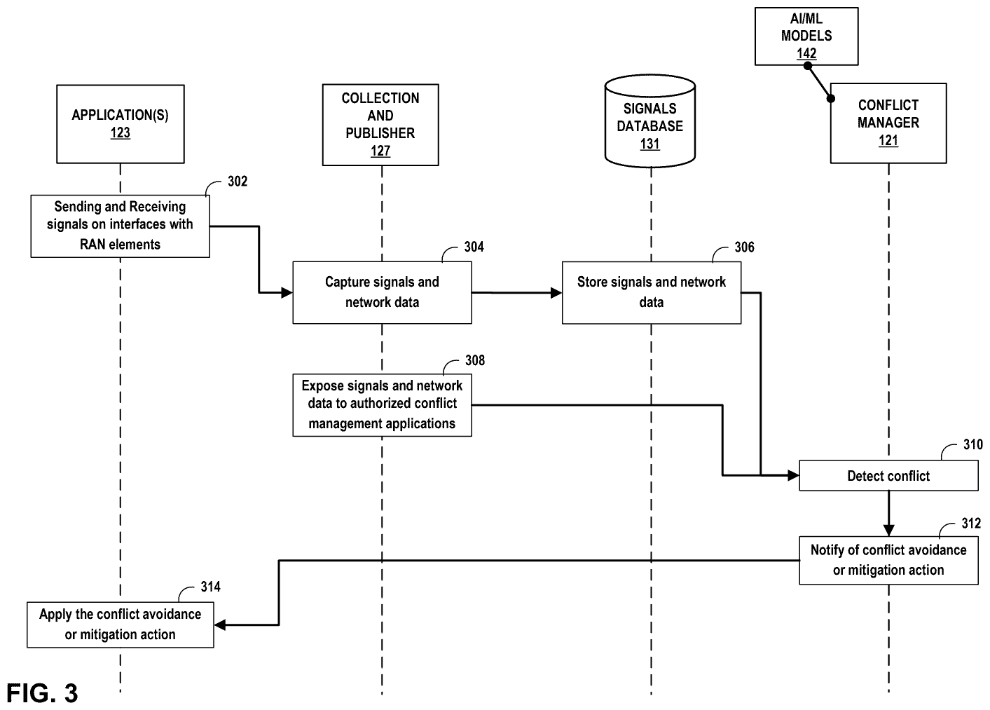

FIG. 3 is a conceptual diagram illustrating operations by services of an SMO system, including a RIC, to avoid or mitigate conflicts that affect resources of a RAN. One or more application(s) 123 send and receive signals on one or more interfaces usable for configuring RAN elements or otherwise managing the RAN (302). The interfaces may include, e.g., an E2 interface with E2 nodes of the RAN, an A1 interface between a near-RT RIC and non-RT RIC, an O1 interface, or an O2 interface, for instance. Signals may include, e.g., a message communicated via an interface, an event reported via the interface, or an action directed via the interfaces.

Collection and publisher service 127 may subscribe to application(s) 123 to capture signals. Collection and publisher service 127 may also obtain network data from elements of the RAN. The network data can include network data usable for evaluating SLA for a network slice in the RAN, evaluating energy usage for network slice in the RAN, or evaluating other performance characteristics of a network slice in the RAN, or of the RAN generally. For example, the network data can include key performance indicators (KPIs), that such throughput, latency, jitter, and packet loss. As other examples, the network data can include resource utilization metrics such as physical resource block (PRB) allocation and scheduler behavior for verifying that each slice receives the guaranteed share of spectrum and compute resources. As other examples, the network data can include reliability data, such as packet error rates and service availability. As other examples, the network data can include end-to-end QoE measurements for confirming that user experiences align with the SLA objectives for eMBB, URLLC, or mMTC services, for instance. Collection and publisher service 127 may obtain the network data via management interface, from a separate telemetry collector, from a network management system or element management system, or by some other mechanism.

Collection and publisher service 127 stores the collected signals and network data to signals database 131 (306). Collection and publisher service 127 exposes selected signals and network data to authorized conflict management applications (308). In this illustrated example, conflict manager 121 is authorized to obtain selected signals and network data, and used the obtained signals and network data to detect a conflict (310). Conflict manager 121 may notify one or more application(s) 123 of the conflict, and may provide a conflict avoidance or mitigation action for the application(s) 123 to apply (312). The application(s) may apply the conflict avoidance or mitigation action.

In an example use case of the above-described techniques, applications 123 may include an energy savings application and a RAN Slice SLA assurance application. The energy savings application may determine to switch one or more cells of a RAN on/off. The energy savings application receives inputs via an O1 Configuration Management interface, with the configuration objects including one or more of the following:
ManagedElement,
GNBCUCPFunction,
GNBCUUPFunction,
GNBDUFunction,
NRCellDU,
NRCellCU
CESManagementFunction (energySavingState, energySavingControl)
NRCellRelation (needed for isESCoveredBy)

The energy savings application collects performance metrics via the O1 interface and uses the performance metrics to determine to switch one or more cells on/off. The performance metrics may include one or more of the following:
RRC.ConnMean
DRB.MeanActiveUeD1.QOS
RRU.PrbTotDI
RRU.PrbTotUl
RRU.PrbUsedDI
RRU.PrbUsedUl
DRB.UEThpD1
DRB.UEThpUl
QosFlow.PdcpPduVolumeDL_Filter
QosFlow.PdcpPduVolumeUl_Filter
PEE.AvgPower
PEE.Energy

Upon determining to switch a cell on or off, the energy savings application modifies the configuration of the cell. As one example procedure, the energy savings application issues a Configuration Modification request for a NRCellCU to update an energySavingControl value of the CESManagementFunction. The energy savings application may set NRCellCU.CESManagementFunction.energySavingControl as “toBeEnergySaving” or “toBeNotEnergySaving”. The energy savings application may receive a Configuration Modification response for the NRCellCU to update the energySavingControl value of the CESManagementFunction. The energy savings application may receive a Configuration Modified notification from the NRCellCU based on the action completion (e.g., confirmation/failure of energySavingControl being set to the desired value). In some cases, an E2 Node/RIC tester follows the Energy Savings activation/deactivation steps.

The SLA assurance application may collect performance metrics using the E2 Service Model for Key Performance Measurements (E2SM-KPM) via the E2 interface connecting the Near-RT RIC to the E2 nodes. Collected metrics for traffic steering may include one or more of the following:
SM.PDUSessionSetupReq.SNSSAI,
SM.PDUSessionSetupSucc.SNSSAI,
SM.PDUSessionSetupFail.Cause,
RRU.PrbUsedUl.SNSSAI,
RRU.PrbUsedDl.SNSSAI,
QosFlow.PdcpPduVolumeDL_Filter.SNSSAI,
QosFlow.PdcpPduVolumeUL_Filter.SNSSAI

The SLA assurance application may use the “Cell Global Id” to associate the cell specific performance metrics with E2SM-CCC in an Action Definition, where the RIC Report may include an Action Definition Format 1 and an Indication Message Format 1.

The SLA assurance application, having determined to modify a cell configuration to facilitate SLA assurance, may control an E2 node using Control Actions via the E2 Service model Control Channel Coordination (CCC). The E2SM-CCC model is focused on coordinating control channels within the RAN. This involves managing resources, scheduling, and optimizing the use of control channels to ensure efficient communication and avoid interference. Control channels are important for the overall operation of the network, as they handle signaling information that coordinates data transmission between network nodes and user equipment.

The SLA assurance application may issue a Control Action with a RIC Service specifying an Action Definition Format 2 and an Indication Message Format 2, to specify configuration data with an O-RRMPolicyRatio structure. The E2 Node being configured (or RIC tester) may responsively allocate PRBs per slice per the “O-RRMPolicyRatio” attributes (e.g., resourceType, rRMPolicyMemberList, rRMPolicyMaxRatio, rRMPolicyMinRatio, and/or rRMPolicyDedicatedRatio) and start reporting cell and slice specific PMs (via E2SM-KPM) according to the new slice resource allocation levels.

The Energy Savings application and SLA assurance have different goals and optimize different sets of parameters, which may at different times and different context conflict. This type of conflict is an “Implicit Conflict,” for the Energy Savings application use case is an rApp (utilizing the O1 interface), while the Slice SLA Assurance use case is an rApp+xApp (utilizing A1/E2 interfaces—where the E2 action logic is in the xApp). The “Implicit Conflict” of an “rApp”/O1 based use case and “rApp/xApp”/E2 based use case is challenging to identify and mitigate because of the differing interfaces, applications, services, and parameters involved.

Conflict manager 121 may be able to detect “Direct Conflicts” generically and without any use case specific information. However, “Implicit Conflict” detection requires higher level logic or use case related information to be provided/embedded to the RIC platform. In some examples, conflict manager 121 detects such conflicts without embedding use case specific logic into the RIC platform by using the subscription/notification mechanism that exists in O1 and E2SM-CCC. Through these 3GPP and O-RAN standards-based subscription/notifications mechanism, the conflict between Energy Savings and SLA Assurance use cases can be detected as follows.

For E2 interface requirements, E2SM-CCC reports Energy Savings state transitions, with RIC Event Trigger Style 1 (Event Trigger Definition Format 2 and Action Definition Format 2), RIC Report Service Style 2 (Action Definition Format 2, Report Definition Format 2, Indication Message Format 2), and the ‘O-CESManagementFunction’ structure. Per RIC subscriptions, the E2 node (or RIC tester) reports “energySavingControl” and “energySavingState” attributes during the transitions according to the Energy Savings use case. ES State Notification via E2SM-CCC may include cesSwitch (this attribute determines whether the energy-saving function is enabled or disabled for a cell), energySavingsState (specifies the status regarding energy-saving in a cell), and energySavingControl (allows the near-RT RIC to initiate energy-saving activation or deactivation).

For O1 interface requirements, O1 Context Management facilitates notifications of ES State transitions, utilizing 3GPP CM Subscribe/Notify procedure to gather the ES state transition updates. For example, the RIC may subscribe to O1 CM ‘CESManagementFunction’ updates and, per RIC O1 CM subscriptions, E2 Node/RIC tester may report “energySavingControl” and “energySavingState” attributes during the transitions within the Energy Savings use case.

Where there is no conflict management, the Energy Savings use case will impact any slice SLA due to switching off one or more cells at times. This impact can be captured to establish a baseline behavior.

In some examples, conflict manager 121 applies a rules-based conflict management approach in which conflict detection and mitigation is based on a pre-defined rule set (rules 129) applied by conflict manager 121. Based on the above-described techniques for FIG. 3 and rules 129, conflict manager 121 may obtain the performance metrics (network data) for both the Energy Savings application and the Slice SLA Assurance application from signals database 131, where these performance metrics have been stored to signals database 131 by collection and publisher service 127. In addition, conflict manager 121 may subscribe to collection and publisher service 127 to obtain O1, A1, and E2 messages sent or received by the Energy Savings application and Slice SLA Assurance application.

Conflict manager 121 may detect a conflict based on applying one or more rules configured by an operator or application. For example, a rule may specify: “If SLA priority=‘high’, DISALLOW (‘Cell Off’) for (CellID C1) in (Slice S1)”. Conflict manager 121 may detect, by monitoring CESManagementFunction, that the Energy Savings application is attempting to switch off CellID C1, such as by detecting the Energy Saving state transition updates, as indicated by energySavingControl parameter in CESManagementFunction being set to “toBeEnergySaving”. If the SLA priority for Slice S1=‘high’, then conflict manager 121 has detected a conflict between the Energy Savings application and Slice SLA Assurance application. Conflict manager 121 may do one or more of the following based on the detected conflict to avoid or mitigate the conflict: (1) notify the Energy Savings application and/or Slice SLA Assurance application, (2) direct the Energy Savings application to belay the configuration of the cell with CellID C1 to be energy saving (e.g., set the energySavingControl parameter in CESManagementFunction being set to “toNotBeEnergySaving”), (3) direct the Slice SLA Assurance application to steer traffic around the cell with CellID C1.

In some examples, conflict manager 121 applies conflict detection and mitigation based on a dynamically adjustable use case priority set by an operator or application. In this approach, an operator may use a user interface generated by user interface module (UI) 786 to set a use case priority. If the operator sets the energy savings use case to have a higher priority, actions of the energy saving application take precedence over actions of the SLA assurance application as part of conflict mitigation. Contrariwise, if the SLA use case has higher priority, actions of the energy savings application may be rejected as part of conflict mitigation.

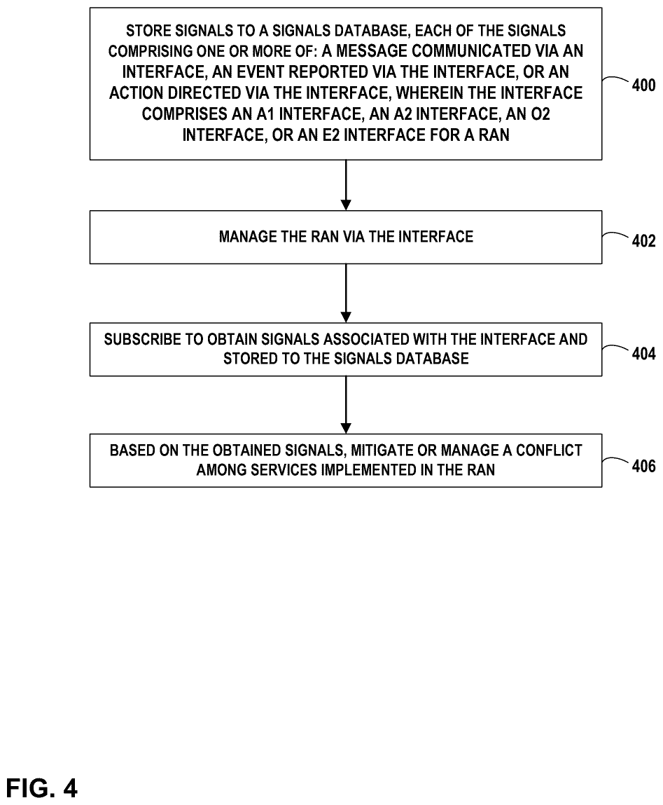

FIG. 4 is a flowchart illustrating an example mode of operation, in accordance with one or more aspects of this disclosure. While described with respect to computing system 700 of FIG. 2 implementing an SMO including a RIC and a conflict manager 121, the mode of may be performed by any suitable computing system. A RIC, which may be, e.g., non-RT RIC 122 or near-RT RIC 124 (FIG. 1A), includes signals database 131. The RIC obtains and stores, to signals database 131, signals associated with an interface (400). The signals may be one or more of: a message communicated via an interface, an event reported via the interface, or an action directed via the interface. The interface may be an A1 interface, an O1 interface, an O2 interface, or an E2 interface for a RAN. One or more managers manage the RAN via the interface by, e.g., sending messages, configuring E2 nodes, and so forth (402).

Conflict manager 121 subscribes to collection and publisher 127 to obtain signals associated with the interface and stored to signals database 131 (404). Based on the obtained signals, conflict manager 121 may mitigate or manage a conflict among services implemented in the RAN (406). The services can include various use cases, such as energy saving, traffic steering, or RAN SLA assurance. The services can include multiple different slices. The services can include services managed by any of service manager 163, O2 services manager 162, O1 services manager 160, or other services implemented by RICs as described elsewhere herein.

The techniques described in this disclosure may be implemented, at least in part, in hardware, software, firmware or any combination thereof. For example, various aspects of the described techniques may be implemented within one or more programmable processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. The term “computer-readable storage media” refers to physical storage media, and not signals, carrier waves, or other transient media.

What is claimed is:

1. A computing system comprising:
one or more storage devices;
processing circuitry having access to the one or more storage devices and configured to execute:
a Radio Access Network (RAN) Intelligent Controller (RIC) comprising:
a signals database configured to store signals, each of the signals comprising one or more of: a message communicated via an interface, an event reported via the interface, or an action directed via the interface, wherein the interface comprises an A1 interface, an O1 interface, an O2 interface, or an E2 interface for a RAN; and
one or more managers to manage the RAN via the interface; and
a conflict manager in communication with the RIC and configured to:
subscribe to obtain signals associated with the interface and stored to the signals database; and
based on the obtained signals, mitigate or manage a conflict among services implemented in the RAN.

2. The computing system of claim 1, the RIC further comprising a collection and publisher service configured to:
receive, from the conflict manager, a request to subscribe to obtain the signals; and
publish, to the conflict manager, the signals.

3. The computing system of claim 2, wherein the conflict manager and the collection and publisher service interact via an open interface.

4. The computing system of claim 1, wherein the conflict manager applies a machine learning-based approach to mitigate or manage the conflict among services implemented in the RAN.

5. The computing system of claim 1, wherein the conflict manager comprises one or more rules that determine one or more of: the signals subscribed to or the mitigation or management of the conflict among the services implemented in the RAN.

6. The computing system of claim 1,
wherein the signals database is configured to store network data associated with the signals, and
wherein to mitigate or manage the conflict among the services implemented in the RAN, the conflict manager is configured to mitigate or manage the conflict among the services based on the signals and the network data associated with the signals.

7. The computing system of claim 1, wherein the RIC provides an extensible framework for a pluggable instance of the conflict manager.

8. A method comprising:
storing, by a computing system to a signals database, signals, each of the signals comprising one or more of: a message communicated via an interface, an event reported via the interface, or an action directed via the interface, wherein the interface comprises an A1 interface, an O1 interface, an O2 interface, or an E2 interface for a Radio Access Network (RAN);
managing, by the computing system, the RAN via the interface;
subscribing, by a conflict manager of the computing system, to obtain signals associated with the interface and stored to the signals database; and
based on the obtained signals, by the conflict manager, mitigating or managing a conflict among services implemented in the RAN.

9. The method of claim 8, further comprising:
receiving, by a collection and publisher service of a RAN Intelligent Controller (RIC), from the conflict manager, a request to subscribe to obtain the signals; and
publishing, by the collection and publisher service, to the conflict manager, the signals.

10. The method of claim 9, wherein the conflict manager and the collection and publisher service interact via an open interface.

11. The method of claim 8, wherein the conflict manager applies a machine learning-based approach to mitigate or manage the conflict among services implemented in the RAN.

12. The method of claim 8, wherein the conflict manager comprises one or more rules that determine one or more of: the signals subscribed to or the mitigation or management of the conflict among the services implemented in the RAN.

13. The method of claim 8,
storing, to the signals database, network data associated with the signals, and
wherein mitigating or managing the conflict among the services implemented in the RAN comprises mitigating or managing the conflict among the services based on the signals and the network data associated with the signals.

14. The method of claim 8, wherein a RAN Intelligent Controller provides an extensible framework for a pluggable instance of the conflict manager.

15. Non-transitory computer-readable media comprising instructions that, when executed, cause processing circuitry of a computing system to:
store, to a signals database, signals, each of the signals comprising one or more of: a message communicated via an interface, an event reported via the interface, or an action directed via the interface, wherein the interface comprises an A1 interface, an O1 interface, an O2 interface, or an E2 interface for a Radio Access Network (RAN);
manage the RAN via the interface;
subscribe, by a conflict manager, to obtain signals associated with the interface and stored to the signals database; and
based on the obtained signals, by the conflict manager, mitigate or manage a conflict among services implemented in the RAN.

16. The media of claim 15, wherein the instructions cause the processing circuitry to:
receive, by a collection and publisher service of a RAN Intelligent Controller (RIC), from the conflict manager, a request to subscribe to obtain the signals; and
publish, by the collection and publisher service, to the conflict manager, the signals.

17. The media of claim 16, wherein the conflict manager and the collection and publisher service interact via an open interface.

18. The media of claim 15, wherein the conflict manager comprises one or more rules that determine one or more of: the signals subscribed to or the mitigation or management of the conflict among the services implemented in the RAN.

19. The media of claim 15, wherein the instructions cause the processing circuitry to:
store, to the signals database, network data associated with the signals, and
wherein to mitigate or manage the conflict among the services implemented in the RAN the instructions cause the processing circuitry to mitigate or manage the conflict among the services based on the signals and the network data associated with the signals.

20. The media of claim 15, wherein a RAN Intelligent Controller provides an extensible framework for a pluggable instance of the conflict manager.
